(19) United States
(12) Patent Application Publication
(10) Pub. No.: US 2026/0279764 A1
(43) Pub. Date: Sep. 17, 2026

(54) LITHIUM-ION SECONDARY BATTERY AND POWER CONSUMING DEVICE

(71) Applicant: ZHUHAI COSMX BATTERY CO., LTD., Zhuhai (CN)

(72) Inventors: Yaming Qiu, Zhuhai (CN); Hai Wang, Zhuhai (CN)

(21) Appl. No.: 19/454,259

(22) Filed: Jan. 20, 2026

(30) Foreign Application Priority Data
Mar. 17, 2025 (CN) 202510310083.2

(51) Int. Cl. H01M 4/133; H01M 4/02; H01M 4/134; H01M 4/36; H01M 4/38; H01M 4/587; H01M 4/62; H01M 4/66; H01M 10/0525; H01M 10/0567; H01M 10/0569; H01M 10/42

(52) U.S. Cl. CPC H01M 4/133; H01M 4/134; H01M 4/364; H01M 4/366; H01M 4/386; H01M 4/587; H01M 4/625; H01M 4/661; H01M 10/0525; H01M 10/0567; H01M 10/0569; H01M 10/4235; H01M 2004/021; H01M 2004/027; H01M 2300/0034; H01M 2300/0042

(57) ABSTRACT

A lithium-ion secondary battery comprises a positive electrode plate, a negative electrode plate, and an electrolyte. The negative electrode plate comprises a copper foil and a negative electrode active layer provided on a surface on at least one side of the copper foil. The negative electrode active layer comprises a negative electrode active material which comprises a silicon-based material and a carbon-based material, with the silicon-based material having a mass content percentage of A % based on the total mass of the negative electrode active material, where 2≤A≤50. The copper foil comprises a Cr element, in a content of B ppm based on the total mass of the copper foil, where 5≤B≤300. The electrolyte comprises a fluorinated solvent in a mass content percentage of C % based on the total mass of the electrolyte, where 2≤C≤70 and B/C≤50.

### CROSS-REFERENCE TO RELATED APPLICATIONS

The present application claims priority to Chinese Patent Application No. 202510310083.2, titled “LITHIUM-ION SECONDARY BATTERY AND POWER CONSUMING DEVICE,” filed on Mar. 17, 2025, the entire contents of which are incorporated herein by reference.

### TECHNICAL FIELD

The present application belongs to the technical field of secondary batteries, and in particular relates to a lithium-ion secondary battery and a power consuming device.

### BACKGROUND ART

With the rapid growth of the 3 C consumer market, new energy vehicles and energy storage markets, there is an increasingly urgent demand for high-energy-density and long-life batteries. As the most prominent and commonly used type of battery at present, lithium-ion batteries have a silicon-based negative electrode material which is the key to improving the energy density of lithium-ion batteries, owing to their extremely high theoretical specific capacity (up to 4200 mAh/g, far exceeding 372 mAh/g of graphite). However, the silicon-based negative electrode undergoes significant volume changes during charging and discharging, which easily leads to electrode structure damage and capacity decay, posing a bottleneck for their commercial application.

### SUMMARY

Therefore, the technical problem to be solved by the present application is to provide a lithium-ion secondary battery and a power consuming device, so as to overcome the defects the silicon-based negative electrode materials in the prior art, which suffer from electrode structure damage, active material detachment, capacity decay, etc., due to volume expansion while improving the energy density.

To this end, the present application provides the following technical solution.

According to an aspect of the present application, provided is a lithium-ion secondary battery comprising a positive electrode plate, a negative electrode plate, and an electrolyte, wherein the negative electrode plate comprises a copper foil and a negative electrode active layer provided on a surface on at least one side of the copper foil, the negative electrode active layer comprising a negative electrode active material which comprises a silicon-based material and a carbon-based material, with the silicon-based material having a mass content percentage of A % based on the total mass of the negative electrode active material, where 2≤A≤50;
the copper foil comprising a Cr element, in a content of B ppm based on the total mass of the copper foil, where 5≤B≤300;
and wherein the electrolyte comprises a fluorinated solvent in a mass content percentage of C % based on the total mass of the electrolyte, where 2≤C≤70 and B/C≤50.

In some optional embodiments, 1≤B/C≤50;
and/or the fluorinated solvent is selected from at least one of fluoro carbonates, fluoro carboxylates, fluorobenzene compounds, and fluoroethers;
preferably, the fluorinated solvent is selected from at least one of ethyl acetate with two fluorine substitutions, fluoroethylene carbonate, methyl trifluoroethyl carbonate, ethyl 2,2,2-trifluoroacetate, 1,1,2,2-tetrafluoroethyl-2,2,3,3-tetrafluoropropyl ether, 1,1,2,2-tetrafluoroethyl-2,2,2-trifluoroethyl ether, p-difluorobenzene compounds, and monofluorobenzene;
preferably, the fluorobenzene compounds have a mass content percentage of 2%-50%, based on the total mass of the electrolyte; preferably, the p-difluorobenzene compounds comprise p-difluorobenzene.

In some optional embodiments, the content of the S element in the copper foil is less than 20 ppm based on the total mass of the copper foil.

In some optional embodiments, the copper foil has a thickness of 3 μm-10 μm;
and/or the copper foil has a tensile strength greater than or equal to 300 MPa, preferably the copper foil has a tensile strength of 300 MPa-800 MPa.

In some optional embodiments, the silicon-based material comprises at least one of a silicon-carbon material and a silicon-oxygen material;
preferably, the silicon-carbon material comprises a porous carbon skeleton and silicon particles located within the pores thereof, further preferably, at least a portion of the surface of the porous carbon skeleton further comprises a carbon coating layer;
and/or the silicon element has a mass content percentage of 10%-80% based on the total mass of the silicon-carbon material.

In some optional embodiments, the silicon-carbon material has a Dv50 of 4 μm-18 μm;
and/or the electrolyte comprises an unsubstituted carboxylate compound in a mass content percentage of 10%-70%, based on the total mass of the electrolyte;
preferably the unsubstituted carboxylate compound comprises at least one of propyl propionate and ethyl propionate.

In some optional embodiments, the negative electrode active material has an average sphericity of greater than or equal to 0.5.

In some optional embodiments, the lithium-ion secondary battery has a capacity of D Ah, where 2≤D≤20.

In some optional embodiments, the electrolyte comprises a lithium salt and an additive;
preferably the additive comprises at least one of a sulfur-containing additive, a boron-containing additive or a nitrile compound.

According to a yet another aspect of the present application, provided is a power consuming device comprising a lithium-ion secondary battery as described above.

The technical solution of the present application has the following advantages.

A lithium-ion secondary battery provided by the present application includes a positive electrode plate, a negative electrode plate, and an electrolyte, wherein the negative electrode plate comprises a copper foil and a negative electrode active layer provided on a surface on at least one side of the copper foil, the negative electrode active layer comprising a negative electrode active material which comprises a silicon-based material and a carbon-based material, with the silicon-based material having a percentage by mass of A % based on the total mass of the negative electrode active material, where 2≤A≤50; the copper foil comprising a Cr element, in a content of B ppm based on the total mass of the copper foil, where 5≤B≤300. According to the lithium-ion secondary battery provided in the present application, the energy density of the battery is significantly improved by the addition of a silicon-based material into a negative electrode active material, and at the same time, the mechanical properties of a copper foil for a negative electrode current collector are improved by the introduction of the chromium element therein. The content of the chromium element and the addition proportion of the silicon-based material are controlled, such that the copper foil can adequately accommodate the expansion and contraction of the silicon-based negative electrode, thereby maintaining the interface stability between the copper foil and the negative electrode active material, effectively preventing the detachment of the negative electrode active material from the copper foil, and suppressing the capacity decay. Furthermore, when the content of a fluorinated solvent and the content of the Cr element in the copper foil satisfy a specific relationship, it is possible to avoid reduced conductivity of the copper foil, increased internal resistance, deteriorated battery kinetics, etc., caused by the presence of the Cr element, and the provided lithium-ion secondary battery achieves an improved energy density while effectively preventing the electrode structure damage and the detachment of the negative electrode material, which results in an improved cycling performance.

### DETAILED DESCRIPTION OF EMBODIMENTS

The following examples are provided for a better understanding of the present application, are not limited to the preferred embodiments, and do not limit the content and scope of protection of the present application, and any product that is identical or similar to the present application, derived from the inspiration of the present application or by combining the present application with other features of the prior art, falls within the scope of protection of the present application.

Unless otherwise defined, all technical and scientific terms used herein have the same meanings as those commonly understood by those skilled in the art to which the present application belongs. The terms used herein are merely for the purpose of describing specific embodiments, but are not intended to limit the present application. The terms “comprising” and “having” and any variations thereof in the present description are intended to cover non-exclusive inclusion.

The phrase “embodiment” mentioned herein means that the specific features, structures, or characteristics described in conjunction with the embodiment can be encompassed in at least one embodiment of the present application. The phrase at various locations in the description does not necessarily refer to the same embodiment, or an independent or alternative embodiment exclusive of another embodiment. Those skilled in the art understand explicitly or implicitly that the embodiment described herein may be combined with another embodiment.

The “ranges” disclosed in the present application are defined in the form of lower and upper limits. A given range is defined by selecting a lower limit and an upper limit, and the selected lower and upper limits defining the boundaries of the particular range. Ranges defined in this manner may be inclusive or exclusive, and may be arbitrarily combined, that is, any lower limit may be combined with any upper limit to form a range. In the present application, unless stated otherwise, the numerical range “a-b” denotes an abbreviated representation of any combination of real numbers between a and b, where both a and b are real numbers. For example, the numerical range “0-5” means that all real numbers between “0-5” have been listed herein, and “0-5” is just an abbreviated representation of combinations of these numerical values. In addition, when a parameter is expressed as an integer of greater than or equal to 2, it is equivalent to disclosing that the parameter can be, for example, an integer of 2, 3, 4, 5, 6, 7, 8, 9, 10, 11, 12, etc.

In the description of the embodiments of the present application, the term “and/or” is merely intended to describe the associated relationship of associated objects, indicating that three relationships can exist. For example, A and/or B may include: only A exists, both A and B exist, and only B exists. In addition, the character “/” herein generally indicates an “or” relationship between the associated objects.

In the description of the embodiments of the present application, the term “at least one” means one or more (including two).

The examples in which experimental steps or conditions are not specified are based on the operations of conventional experimental steps or conditions described in documents in the art. The reagents or instruments used without indicating a manufacturer are all commercially available conventional reagent products.

As described in the background art, in order to overcome the defects of the silicon-based negative electrode materials in the prior art, which suffer from electrode structure damage, active material detachment, capacity decay, etc., due to volume expansion while improving the energy density, the present application provides the following technical solutions.

According to an aspect of the present application, provided is a lithium-ion secondary battery comprising a positive electrode plate, a negative electrode plate, and an electrolyte, wherein the negative electrode plate comprises a copper foil and a negative electrode active layer provided on a surface on at least one side of the copper foil, the negative electrode active layer comprising a negative electrode active material which comprises a silicon-based material and a carbon-based material, with the silicon-based material having a mass content percentage of A % based on the total mass of the negative electrode active material, where 2≤A≤50; the copper foil comprising a Cr element, in a content of B ppm based on the total mass of the copper foil, where 5≤B≤300;
and wherein the electrolyte comprises a fluorinated solvent in a mass content percentage of C % based on the total mass of the electrolyte, where 2≤C≤70 and B/C≤50.

As an example, the mass percentage of the silicon-based material may be 2%, 7%, 10%, 15%, 20%, 25%, 30%, 35%, 40%, 45%, 50%, or within the range of the foregoing values, based on the total mass of the negative electrode active material; The content of the Cr element in the copper foil may be 5 ppm, 20 ppm, 50 ppm, 80 ppm, 100 ppm, 120 ppm, 150 ppm, 200 ppm, 250 ppm, 300 ppm or within the range of the foregoing values, based on the total mass of the copper foil. The mass content percentage of the fluorinated solvent in the electrolyte may be 2%, 7%, 10%, 15%, 20%, 25%, 30%, 35%, 40%, 45%, 50%, 55%, 60%, 65%, 70% or within the range of the foregoing values, based on the total mass of the electrolyte. The value of B/C may be 1, 3, 5, 7, 10, 15, 20, 25, 30, 35, 40, 45, 50, or within the range of the foregoing values.

It should be noted that the copper foil for a negative electrode current collector serves as the carrier of the negative electrode active material, and the performance thereof directly affects the stability of the negative electrode structure and the transport efficiency of lithium ions. The lithium-ion secondary battery provided by the present application enables the significant improvement of the energy density of the battery by adding a specific proportion of the silicon-based material to the negative electrode active material. In addition, in order to avoid the effect of the volume expansion of the silicon-based material during charge-discharge cycling, a chromium element is also introduced into the copper foil for a negative electrode current collector. The introduction of chromium into the copper foil can improve the mechanical properties of the copper foil, enabling it to better withstand the stress caused by the volume changes of the silicon-based material. By controlling the content of chromium element in the copper foil and the addition proportion of silicon-based material, the interface stability between the copper foil and the negative electrode active material can be maintained, thus suppressing electrode expansion induced by silicon, effectively preventing the detachment of the negative electrode active material from the copper foil, and suppressing the capacity decay. Furthermore, when the content of a fluorinated solvent and the content of the Cr element in the copper foil satisfy a specific relationship, it is possible to avoid reduced conductivity of the copper foil, increased internal resistance, deteriorated battery kinetics, etc., caused by the presence of the Cr element, and the provided lithium-ion secondary battery achieves an improved energy density while effectively preventing the electrode structure damage and the detachment of the negative electrode material, which results in improved cycling performance. It should be noted that the optimization of the copper foil and the electrolyte is not an isolated process but rather an interrelated and mutually reinforcing one. The presence of a Cr element in the copper foil affects the conductivity of the copper foil, leading to an increased internal resistance and deteriorated battery kinetics, which in turn promotes lithium plating of the battery during room-temperature cycling and results in significantly deteriorated cycling performance and expansion. Therefore, the coordinated control of the content of a Cr element and the content of a fluorinated solvent in the copper foil is critical for improving the cycling and expansion of silicon-containing lithium-ion secondary batteries. The addition of a fluorinated solvent can improve electrolyte kinetics to some extent, increase the migration rate of lithium ions, reduce the internal resistance of the battery, and further reduce the risk of lithium plating, thereby improving cycling performance and reducing the expansion of the negative electrode. Moreover, fluorinated solvents can form a dense protective film on the surface of the negative electrode, reducing the direct contact between the electrolyte and the silicon-based material, inhibiting the decomposition of the electrolyte and the irreversible consumption of lithium ions, reducing the risk of battery cycling deterioration caused by lithium plating, and reducing the accumulation of by-products and expansion of the negative electrode during the cycling process. If the content of a chromium element in the copper foil is too high, the conductivity of the copper foil will decrease significantly, affecting the charge-discharge performance of the battery. If the content of a chromium element in the copper foil is too low, it cannot effectively accommodate the expansion and contraction of the silicon-containing negative electrode. If the silicon-based material content is too high, the negative electrode will expand too much, which will cause cracks and pulverization of the negative electrode, and degrade the contact between the negative electrode active material and the copper foil current collector. This will easily cause the negative electrode active material to detach from the electrode plate, which will not only reduce the capacity, but also increase the internal resistance of the battery. The detached material will accumulate inside the battery and cause a short circuit, which may lead to thermal runaway of the battery, causing safety accidents such as fire and explosion, and significantly deteriorating the battery cycling performance. If the silicon-based material content is too low, the energy density of the battery will increase too little. If there is too little fluorinated solvent, the formation of the negative electrode film is affected, resulting in insufficient electrolyte kinetics and deterioration of cycling performance. If there is too much fluorinated solvent, no further improvement in battery cycling stability is achieved and the cost of the electrolyte will increase significantly. If the B/C ratio is too high, it indicates that the content of a Cr element is relatively high compared to the fluorinated solvent. In this case, the Cr element will cause lithium plating during room temperature cycling, and the fluorinated solvent will not compensate enough, resulting in a deterioration in battery cycling performance. If the B/C ratio is too low, it indicates that the content of a Cr element is relatively low compared to the fluorinated solvent. In this case, the Cr element and the fluorinated solvent are difficult to achieve the effect of coordinated improvement of the interface and enhancement of the battery performance.

In the present application, the content of a Cr element and an S element in a copper foil is determined by a method as follows:

The negative electrode plate is taken out from the battery, the surface-active material layer of the negative electrode plate is removed to leave the remaining foil substrate, and a plurality of electrode plate foil substrates having a dimension of 2 cm×2 cm are randomly cut with ceramic scissors, ultrasonically cleaned sequentially in acetone, ethanol, or deionized water (5-10 minutes) to remove surface grease, binder residues, or process contaminants, and dried. The sample is ground into a powder and the copper matrix and metallic impurities are dissolved with a mixed acid of HNO₃ (65 wt %) and HCl (37 wt %) in a mass ratio of 3:1, and a small amount of HF (hydrofluoric acid) or H₂O₂ is added to assist in digesting other insoluble substances, and finally the contents of Cr and S are quantified by inductively coupled plasma atomic emission spectrometry (ICP).

In some optional embodiments, 1≤B/C≤50;
and/or the fluorinated solvent is selected from at least one of fluoro carbonates, fluoro carboxylates, fluorobenzene compounds, and fluoroethers;
preferably, the fluorinated solvent is selected from at least one of ethyl acetate with two fluorine substitutions, fluoroethylene carbonate, methyl trifluoroethyl carbonate, ethyl 2,2,2-trifluoroacetate, 1,1,2,2-tetrafluoroethyl-2,2,3,3-tetrafluoropropyl ether, 1,1,2,2-tetrafluoroethyl-2,2,2-trifluoroethyl ether, p-difluorobenzene compounds, and monofluorobenzene;
preferably, the fluorobenzene compounds have a mass content percentage of 2%-50%, based on the total mass of the electrolyte; preferably, the p-difluorobenzene compounds comprise p-difluorobenzene.

The ethyl acetate with two fluorine substitutions comprises at least one selected from ethyl 2,2-difluoroacetate and 2,2-difluoroethyl acetate, the abbreviation for 2,2-difluoroethyl acetate is DFEA.

As an example, the mass content percentage of the p-difluorobenzene compounds in the electrolyte can be 2%, 3%, 5%, 10%, 15%, 20%, 25%, 30%, 35%, 40%, 45%, 50%, or within the range of the foregoing values.

In the present application, the p-difluorobenzene compounds include p-difluorobenzene and derivatives thereof, with the derivatives including but not limited to those formed by adding fluorine, alkyl groups, or fluoroalkyl groups to the p-difluorobenzene structure. Preferably, the p-difluorobenzene compounds comprise p-difluorobenzene.

Those skilled in the art will understand that silicon-based materials that can improve energy density may deteriorate the battery kinetics and easily lead to lithium plating on the negative electrode. In contrast, the p-difluorobenzene compounds have a relatively low viscosity. An appropriate amount of p-difluorobenzene compounds can ensure the overall kinetics of the battery, thereby improving the fast-charge cycling stability of the battery, and reducing lithium plating during cycling, which could otherwise cause excessive expansion. However, difluorobenzene compounds do not dissolve lithium salts, so they cannot be added at a too high amount. If the amount is too high, the lithium salts will not dissolve completely, and the electrolyte will be unacceptable and cannot be used in the preparation of lithium-ion secondary batteries.

In some optional embodiments, the content of the S element in the copper foil is less than 20 ppm based on the total mass of the copper foil. As an example, the content of the S element in copper foil can be 0 PPm, 1 ppm, 3 ppm, 5 ppm, 7 ppm, 9 ppm, 10 ppm, 12 ppm, 14 ppm, 16 ppm, 18 ppm, 19 ppm, or within the range of the foregoing values.

In the present application, the presence of a sulfur element in the copper foil will affect the conductivity of the copper foil and may cause side reactions with the electrolyte, producing unstable byproducts and affecting the interface stability between the negative electrode active material and the copper foil. Therefore, the content needs to be controlled to below 20 ppm. Those skilled in the art will understand that the lower the content of the sulfur element in the copper foil, the better. However, it is inevitable that the S element will be introduced into the copper foil, and the lower the content of the sulfur element, the more difficult it is to control. Therefore, in the present application, it is sufficient to control the content of the sulfur element in the copper foil to below 20 ppm.

In some optional embodiments, the copper foil has a thickness of 3 μm-10 μm;
and/or the copper foil has a tensile strength greater than or equal to 300 MPa, preferably the copper foil has a tensile strength of 300 MPa-800 MPa.

As an example, the thickness of the copper foil may be 3 μm, 4 μm, 5 μm, 6 μm, 7 μm, 8 μm, 9 μm, 10 μm, or within the range of the foregoing values. The tensile strength of the copper foil may be 300 MPa, 350 MPa, 400 MPa, 450 MPa, 500 MPa, 550 MPa, 600 MPa, 650 MPa, 700 MPa, 750 MPa, 800 MPa, or within the range of the foregoing values. In the present application, the tensile strength of the copper foil can be determined using methods and equipment known in the art, for example, by means of a tensile tester, with common test standards including IPC-TM-650 2.4.18.1A, ASTM E345-2016, GB/T 5230-1995, GB/T 5187-2008, GB/T 228.1, etc., which specify key parameters such as a sample dimension, a test rate, and a grip separation.

It should be noted that while a lower copper foil thickness can improve the energy density of the battery, an excessively low copper foil thickness may fail to provide sufficient mechanical support. A moderately thinned copper foil reduces the weight and volume while maintaining sufficient mechanical strength, creating conditions for enhancing the overall energy density of the battery. Meanwhile, a copper foil with a sufficient strength can better withstand the stress induced by volume changes in silicon-based materials. By controlling the thickness of the copper foil and tensile strength thereof within the above ranges, the normal battery cycling can be ensured while improving energy density. Additionally, the contraction and expansion of the negative electrode caused by silicon-based materials is alleviated, thereby further enhancing the stability and bonding strength of the interface between the negative electrode material and the copper foil.

In some optional embodiments, the silicon-based material comprises at least one of a silicon-carbon material and a silicon-oxygen material;
preferably, the silicon-carbon material comprises a porous carbon skeleton and silicon particles located within the pores thereof, further preferably, at least a portion of the surface of the porous carbon skeleton further comprises a carbon coating layer.

It will be appreciated by those skilled in the art that depositing silicon particles in pores of a porous carbon skeleton may limit the volume expansion of the silicon particles and mitigate the effects of volume changes on the negative electrode. Furthermore, the application of a carbon coating layer on the surface of the porous carbon can improve the conductivity of the material, which in turn improves the overall performance of the battery.

In some optional embodiments, the composition of the carbon coating layer is conventional in the art. As an example, the carbon coating layer comprises at least one of a carbon material or a polymer. Optionally, the carbon material includes at least one of soft carbon, hard carbon, graphene, graphite, carbon nanotubes, or carbon black, and the polymer includes an aromatic polymer, such as at least one of polybenzene, polynaphthalene, polyanthracene, polyphenanthrene, polybiphenyl, polyterphenyl, etc.

In some optional embodiments, the silicon element has a mass content percentage of 10%-80% based on the total mass of the silicon-carbon material. As an example, the mass content percentage of the silicon element in the silicon-based material can be 10%, 20%, 30%, 35%, 40%, 45%, 50%, 55%, 60%, 65%, 70%, 75%, 80% or within the range of the foregoing values.

In some optional embodiments, the silicon-carbon material has a Dv50 of 4 μm-18 μm; and/or the electrolyte comprises an unsubstituted carboxylate compound in a mass content percentage of 10%-70%, based on the total mass of the electrolyte.

As an example, the Dv50 of the silicon-carbon material may be 4 μm, 5 μm, 6 μm, 7 μm, 8 μm, 9 μm, 10 μm, 11 μm, 12 μm, 14 μm, 15 μm, 16 μm, 18 μm, or within the range of the foregoing values. The mass content percentage of the carboxylate compound in the electrolyte can be 10%, 15%, 20%, 25%, 30%, 35%, 40, 45% 50%, 55%, 60%, 65%, 70%, or within the range of the foregoing values. As an example, the unsubstituted carboxylate compound includes, but is not limited to, at least one of ethyl propionate (EP), propyl propionate (PP), etc.

It is understood that the smaller the particle size of the silicon-carbon material, the better the kinetics, but the more pronounced the side reactions. The higher the content of unsubstituted carboxylate compounds, the better the kinetics of the electrolyte, and the better the fast-charging performance, but the more pronounced the side reactions. By controlling the particle size of the silicon-carbon material and the content of the unsubstituted carboxylate compound in the above range, the fast-charging kinetics and cycling stability of the battery can be ensured while reducing the lithium plating during cycling and preventing excessive expansion during the cycling.

In some optional embodiments, the negative electrode active material has an average sphericity of greater than or equal to 0.5. As an example, the average sphericity of the negative electrode active material is 0.5, 0.55, 0.6, 0.65, 0.7, 0.75, 0.8, 0.85, 0.9, 0.95, 0.98, or within the range of the foregoing values. In the present application, the average sphericity of the negative electrode active material can be determined using methods and settings known in the art. For example, the image of each particle in an SEM micrograph of the composite material at a given magnification (e.g., 2500×) is analyzed by means of image processing software (e.g., Image Pro Plus), so as to obtain the perimeter and area of each particle; the perimeter-equivalent radius r1 and the area-equivalent radius r2 of each particle are separately calculated, and then the sphericity of each particle satisfies S=r2/r1; and the number-weighted average of the sphericity of all the particles is calculated so as to obtain the average sphericity of the composite material.

It is understood that the sphericity is a parameter characterizing the morphology of a particle; the closer the morphology of a particle is to a sphere, the closer the sphericity is to 1. According to the present application, by controlling the sphericity of the silicon-carbon material within an appropriate range, the uniformity of the material can be ensured, but too high sphericity will increase the process difficulty or cost. The lower the sphericity, the more irregular the shape of the silicon-carbon material. Irregularly shaped silicon-carbon material particles can become crack sources, leading to significant deterioration of the material-electrolyte interface, increased side reactions, increased heat generation, and decreased battery cycling stability. By limiting the sphericity of the silicon-carbon material to the above range in the application, the cycling stability of the battery can be further improved.

In some optional embodiments, the lithium-ion secondary battery has a capacity of D Ah, where 2≤D≤20.

As an example, the capacity of the lithium-ion battery may be 2 Ah, 4 Ah, 5 Ah, 8 Ah, 10 Ah, 12 Ah, 15 Ah, 17 Ah, 19 Ah, 20 Ah, or within the range of the foregoing values. In the present application, the method for testing the capacity of a battery is conventional in the art, and may in particular comprise: the lithium-ion secondary battery is subjected to charging-discharging within a charge-discharge cut-off voltage range of 3.0-4.45 V at a rate of 1 C at 25° C., and the discharge capacity after full charge is tested and recorded as the capacity of the battery.

It will be appreciated by those skilled in the art that when the capacity of the battery is high, the size of the battery increases accordingly. As the gap between the outer package and the cell becomes smaller in proportion to the overall battery size, the expansion of the silicon-containing negative electrode has a greater impact on the outer package, making the battery more prone to deformation. By limiting the capacity of the lithium-ion secondary battery to the above range in the application, the overall stability of the battery can be further guaranteed, and the cycling stability of the battery can be ensured.

In some optional embodiments, the electrolyte comprises a lithium salt and an additive. Alternatively, in the electrolyte, the molar concentration of the lithium salt may be 0.5-3 mol/L; and the mass content percentage of the additive is 2-10%. As an example, the molar concentration of the lithium salt in the electrolyte can be 0.5 mol/L, 0.8 mol/L, 1.0 mol/L, 1.2 mol/L, 1.4 mol/L, 1.5 mol/L, 1.6 mol/L, 1.8 mol/L, 2.0 mol/L, 2.2 mol/L, 2.5 mol/L, 2.7 mol/L, 3 mol/L, or within the range of the foregoing values. The mass content percentage of the additive can be 2%, 3%, 4%, 5%, 6%, 7%, 8%, 9%, 10%, or within the range of the foregoing values.
preferably the additive comprises at least one of a sulfur-containing additive, a boron-containing additive or a nitrile compound.

As an example, the sulfur-containing additive comprises a sulfonate additive, including but not limited to one or more of 1,3-propanesultone (PS), 1-propene-1,3-sultone (PST), 5-methyloxathiolane 2,2-dioxide (CAS No. 3289-23-4), 1,3-propenesultone, 2,4-butanesultone, and 1,4-butanesultone. The boron-containing additive comprises at least one of, including but not limited to, LiDFOB and LiBOB. The nitrile compound comprises one or more of, including but not limited to, 1,3,6-hexanetricarbonitrile (HTCN), adiponitrile (ADN), succinonitrile (SN), ethylene glycol bis(propionitrile) ether (DENE), and tris(3-cyanopropyl) phosphate (PCN).

It will be appreciated by those skilled in the art that the sulfur-containing additives in the electrolyte primarily function to improve the interfacial properties between the electrode plate and the electrolyte, reduce the internal resistance of the battery, enhance charge-discharge efficiency of the battery, and improve the low-temperature performance of the battery; the boron-containing additives enables the formation of a protective film on the surface of the positive electrode of the battery, and stabilization of the interface between the electrode plate and the electrolyte, thereby preventing oxidative decomposition of the electrolyte and improving the performance and cycling stability of the battery; and the nitrile compounds can improve the high-temperature and high-voltage performance of the battery.

It will be appreciated by those skilled in the art that the electrolyte further comprises an unsubstituted carbonate solvent, including but not limited to at least one of ethylene carbonate (EC), propylene carbonate (PC), diethyl carbonate (DEC), etc.

It will be appreciated by those skilled in the art that the lithium-ion secondary battery also includes structural components such as separators and housings, and during the charging and discharging process of the battery, lithium ions are intercalated and de-intercalated back and forth between the positive electrode plate and the negative electrode plate, the electrolyte functions to conduct ions between the positive electrode plate and the negative electrode plate, and the separator is arranged between the positive electrode plate and the negative electrode plate, mainly prevents positive and negative electrodes from short-circuiting, and enables the passage of lithium ions.

As an example, the positive electrode plate includes a positive current collector and a positive active material layer, wherein the positive electrode current collector has two surfaces opposite in its own thickness direction, and the positive electrode active material layer is provided on either or both of the two opposite surfaces of the positive electrode current collector.

The material and composition of the positive electrode plate and the preparation method therefor used in the lithium-ion secondary battery of the present application may include any of the techniques disclosed in the prior art.

As an example, the negative electrode plate includes a negative electrode current collector and a negative electrode active material layer, wherein the negative electrode current collector has two opposite surfaces in its own thickness direction, and the negative electrode active material layer is provided on either or both of the two opposite surfaces of the negative electrode current collector. The other materials and composition of the negative electrode plate and the preparation method therefor used in the lithium-ion secondary battery of the present application may include any of the techniques disclosed in the prior art.

The material and shape of the separator used in the lithium-ion secondary battery of the present application is not particularly limited and may any of the techniques disclosed in the prior art.

The electrolyte used in the lithium-ion secondary battery of the present application may also include any of the techniques disclosed in the prior art.

According to a yet another aspect of the present application, provided is a power consuming device comprising a lithium-ion secondary battery as described above.

The lithium-ion secondary battery can be used as a power supply for the power consuming device, or can also be used as an energy storage unit for the power consuming device. The power consuming device may be, but is not limited to, a mobile device (e.g., a mobile phone, a laptop computer, etc.), an electric vehicle (e.g., a pure electric vehicle, a hybrid electric vehicle, a plug-in hybrid electric vehicle, an electric bicycle, an electric scooter, an electric golf cart, an electric truck, etc.), an electric train, ship and satellite, an energy storage system, and the like.

The present application will be further described in detail below with reference to specific examples, which cannot be construed as limiting the scope of protection of the present application.

### Example 1

The present embodiment provides a lithium-ion secondary battery, and the specific composition thereof and preparation method therefore are as follows.

### 1) Preparation of Positive Electrode Plate

A positive electrode active material of Lithium cobalt oxide (LiCoO₂), polyvinylidene fluoride (PVDF), SP (super P) and carbon nanotubes (CNTs) were mixed in a mass ratio of 96:2:1.5:0.5, N-methylpyrrolidone (NMP) was added, and the mixture was stirred under the action of a vacuum stirrer until the mixed system became a positive electrode active slurry with a uniform flowability. The positive electrode active slurry was uniformly coated onto both surfaces of an aluminum foil. The coated aluminum foil is dried, then subjected to rolling and slitting to obtain the desired positive electrode plate with an areal density of 13 mg/cm² and a compaction density of 4.2 mg/cm³.

### 2) Preparation of Negative Electrode Plate

A negative electrode active material (including artificial graphite and a silicon-carbon material, wherein the silicon-carbon material constituted 15% by mass of the negative electrode active material in this example), sodium carboxymethyl cellulose (CMC-Na), a styrene-butadiene rubber, conductive carbon black (SP), and single-walled carbon nanotubes (SWCNTs) were mixed in a mass ratio of 94.5:2.5:1.5:1:0.5, and deionized water was added and stirred under the action of a vacuum stirrer to obtain a negative electrode active slurry; the negative electrode active slurry was uniformly coated onto both surfaces of a copper foil, wherein the thickness of the copper foil was 5 μm, and the content of a Cr element in the copper foil was 97 ppm, the content of S element was 1 ppm and the tensile strength of the copper foil was 672 MPa; the silicon-carbon material comprised a porous carbon skeleton having a carbon coating layer on the surface, and silicon particles deposited in pores of the porous carbon skeleton, and in this example, the silicon-carbon material had a mass content percentage of 47% and Dv50 of 9 m, and the negative electrode active material had an average sphericity of 0.8; and after the coated copper foil was air-dried at room temperature and then dried in an oven at 80° C. for 10 h, and then subjected to cold pressing and slitting to obtain a negative electrode plate, which had an areal density of 4 mg/cm² and a compacted density of 1.75 mg/cm³.

### 3) Preparation of Electrolyte

In a glovebox filled with argon (H₂O<0.1 ppm, O₂<0.1 ppm), ethylene carbonate (EC)/propylene carbonate (PC) in a mass ratio of 1:1 were used as the basic components; EC, PC, PP, EP, and p-difluorobenzene were thoroughly mixed, wherein the mass content percentages of PP, EP, and p-difluorobenzene relative to the total mass of the electrolyte were controlled at 10%, 4%, and 2%, respectively. Then 12 wt % (relative to the total mass of the electrolyte) of thoroughly dried lithium hexafluorophosphate (LiPF₆) was rapidly added, along with a specified amount of FEC and DFEA (when the total content of these two >15 wt %, the mass content percentage of FEC was 15 wt % and that of DFEA was [total content of a fluorinated solvent-fluorobenzene compound content-15] wt %; when the total content was ≤15 wt %, the fluorinated solvent is a mixture of FEC and fluorobenzene compound), and in this example, the total content of a fluorinated solvent accounted for 60 wt % relative to the total mass of the electrolyte, that is, the mass content percentage of FEC was 15 wt % and the mass content percentage of DFEA was 43 wt %. Subsequently, 1% of octamethylcyclotetrasiloxane, 3% of PS, 1% of LiDFOB, 2 wt % of HTCN, and 1 wt % of ADN were added, all percentages being based on the total mass of the electrolyte. After stirring until uniform, the mixture passed the tests of moisture and free acid and was confirmed to meet specifications, then the desired electrolyte was obtained.

### 4) Preparation of Lithium Ion Battery

The positive electrode plate of step 1), the negative electrode plate of step 2), and the separator (Model Celgard 2325, Asahi Kasei) were stacked in the order of the positive electrode plate, the separator, and the negative electrode plate, and then wound to obtain a cell. The cell was placed into an aluminum foil outer package, and the electrolyte of step 3 was injected into the outer package, and then vacuum-packaging, leaving to stand, forming, shaping, sorting and other steps were performed to obtain a lithium-ion secondary battery with a capacity of 5.2 Ah.

### Examples 2-16

Examples 2 to 16 differed from Example 1 in that the composition of the negative electrode plate or the content of the fluorinated solvent was different, as detailed in the following table. It should be noted that when the content of basic components in the electrolyte was changed, the part that is less than 100% or exceeds 100% was regulated by using the basic components. For example, in Example 4, the mass content percentage of the fluorinated solvent was reduced compared to that in Example 1, and the reduced part will be made up to 100% using the basic component. The same applies below.

TABLE 1

| | | | | | Silicon-carbon | | | | | |
|---|---|---|---|---|---|---|---|---|---|---|
| | Copper foil | | | | material | | | | | |
| | | | S | Tensile | | Si | | | | |
| | Thickness, | B, | content, | strength, | | content, | | Average | C, | |
| Group | μm | ppm | ppm | MPa | Dv50 | % | A | sphericity | % | B/C |
| Example 1 | 5 | 97 | 1 | 672 | 9 | 47 | 15 | 0.8 | 60 | 1.62 |
| Example 2 | 5 | 5 | 1 | 624 | 9 | 47 | 15 | 0.8 | 60 | 0.08 |
| Example 3 | 5 | 300 | 1 | 698 | 9 | 47 | 15 | 0.8 | 60 | 5 |
| Example 4 | 5 | 250 | 1 | 693 | 9 | 47 | 15 | 0.8 | 7 | 35.71 |
| Example 5 | 5 | 97 | 22 | 672 | 9 | 47 | 15 | 0.8 | 60 | 1.62 |
| Example 6 | 5 | 97 | 1 | 280 | 9 | 47 | 15 | 0.8 | 60 | 1.62 |
| Example 7 | 5 | 97 | 1 | 550 | 9 | 47 | 15 | 0.8 | 60 | 1.62 |
| Example 8 | 5 | 97 | 1 | 750 | 9 | 47 | 15 | 0.8 | 60 | 1.62 |
| Example 9 | 5 | 97 | 1 | 672 | 6 | 47 | 15 | 0.8 | 60 | 1.62 |
| Example 10 | 5 | 97 | 1 | 672 | 3 | 47 | 15 | 0.8 | 60 | 1.62 |
| Example 11 | 5 | 97 | 1 | 672 | 9 | 10 | 15 | 0.8 | 60 | 1.62 |
| Example 12 | 5 | 97 | 1 | 672 | 9 | 85 | 15 | 0.8 | 60 | 1.62 |
| Example 13 | 5 | 97 | 1 | 672 | 9 | 47 | 15 | 0.7 | 60 | 1.62 |
| Example 14 | 5 | 97 | 1 | 672 | 9 | 47 | 15 | 0.4 | 60 | 1.62 |
| Example 15 | 5 | 97 | 1 | 672 | 9 | 47 | 50 | 0.8 | 60 | 1.62 |
| Example 16 | 5 | 97 | 1 | 672 | 9 | 47 | 2 | 0.8 | 60 | 1.62 |
| Example 17 | 5 | 97 | 1 | 672 | 9 | 47 | 25 | 0.8 | 60 | 1.62 |
| Example 18 | 5 | 97 | 1 | 672 | 9 | 47 | 35 | 0.8 | 60 | 1.62 |

### Examples 19-27

Examples 19-25 differed from Example 4 in that the composition of the electrolyte was different, as detailed in the table below. In Examples 22-24, the mass ratio of PP to EP in the unsubstituted carboxylate compounds was 5:2.

TABLE 2

| | | Unsubstituted | | |
|---|---|---|---|---|
| | | carboxylate | p- | |
| Group | C, % | compound, % | difluorobenzene, % | D, Ah |
| Example 4 | 7 | 14 | 2 | 5.2 |
| Example 19 | 70 | 14 | 2 | 5.2 |
| Example 20 | 7 | 8 | 2 | 5.2 |
| Example 21 | 7 | 10 | 2 | 5.2 |
| Example 22 | 7 | 70 | 2 | 5.2 |
| Example 23 | 7 | 14 | 1 | 5.2 |
| Example 24 | 7 | 14 | 3.1 | 5.2 |
| Example 25 | 7 | 0 | 2 | 5.2 |
| Example 26 | 7 | 14 | 0 | 5.2 |
| Example 27 | 7 | 14 | 2 | 8 |
| Comparative | 4 | 14 | 2 | 5.2 |
| Example 4 | | | | |

### Example 28

This example provided a lithium-ion secondary battery, differing from Example 1 in that an equal mass of monofluorobenzene was used instead of p-difluorobenzene.

### Example 29

This example provided a lithium-ion secondary battery, differing from Example 1 in that an equal mass of a silicon-oxygen material was used instead of silicon-carbon materials.

### Example 30

This example provided a lithium-ion secondary battery, differing from Example 1 in that the electrolyte contained no PS, HTCN and ADN.

### Example 31

This example provided a lithium-ion secondary battery, differing from Example 1 in that the electrolyte contained no LiDFOB, HTCN and ADN.

### Example 32

This example provided a lithium-ion secondary battery, differing from Example 1 in that the electrolyte contained no PS and LiDFOB.

### Comparative Example 1

This comparative example provided a lithium-ion secondary battery, differing from Example 19 only in that a conventional copper foil was used, wherein the content of the Cr element was approximately 0 ppm.

### Comparative Example 2

This comparative example provided a lithium-ion secondary battery, differing from Example 19 only in that the content of the Cr element in the copper foil was 500 ppm.

### Comparative Example 3

This comparative example provided a lithium-ion secondary battery, differing from Example 19 only in that the percentage of the silicon-based material was 70%.

### Comparative Example 4

This comparative example provided a lithium-ion secondary battery, differing from Example 4 only in the content of the fluorinated solvent, see Table 2 for details.

### TEST EXAMPLES

### 1. Test for Cycling Performance at Room Temperature (25° C.)

The lithium-ion secondary batteries provided in each example and comparative example were subjected to charge-discharge cycling at 25° C. at a 2 C rate within a charge-discharge cut-off voltage range of 3.0-4.45 V; the discharge capacity in the first cycle was test and recorded as x1 mAh, and the discharge capacity in the Nth cycle was test and recorded as y1 mAh. The cycling capacity retention rate in the Nth cycle, R1=y1/x1×100%, and the number of cycles at which cycling capacity retention rate R1 reached 80% was recorded.

### 2. Test for Cycling Expansion at Room Temperature (25° C.)

The lithium-ion secondary batteries provided in each example and comparative example were subjected to charge-discharge cycling at 25° C. at a 2 C rate within a charge-discharge cut-off voltage range of 3.0-4.45 V; the battery thickness after discharge in the first cycle was recorded as x2 mm, and the thickness after the discharge in the Nth cycle was recorded as y2 mm. The thickness expansion increase rate in the Nth cycle, R2=(y2/x2−1)×100%, and the number of cycles at which thickness expansion increase rate R2 reached 12% was recorded.

The results of the specific tests were detailed in the table below.

TABLE 3

| | Number of | Number of |
|---|---|---|
| | cycles at | cycles at |
| | which R1 = | which R2 = |
| Group | 80% | 12% |
| Example 1 | 817 | 846 |
| Example 2 | 801 | 812 |
| Example 3 | 798 | 823 |
| Example 4 | 711 | 779 |
| Example 5 | 767 | 813 |
| Example 6 | 701 | 688 |
| Example 7 | 801 | 809 |
| Example 8 | 824 | 886 |
| Example 9 | 783 | 823 |
| Example 10 | 703 | 811 |
| Example 11 | 885 | 912 |
| Example 12 | 693 | 671 |
| Example 13 | 789 | 814 |
| Example 14 | 696 | 723 |
| Example 15 | 632 | 605 |
| Example 16 | 1030 | 1187 |
| Example 17 | 785 | 788 |
| Example 18 | 729 | 722 |
| Example 19 | 816 | 844 |
| Example 20 | 734 | 721 |
| Example 21 | 796 | 803 |
| Example 22 | 798 | 792 |
| Example 23 | 759 | 766 |
| Example 24 | 803 | 825 |
| Example 25 | 654 | 690 |
| Example 26 | 781 | 792 |
| Example 27 | 787 | 768 |
| Example 28 | 762 | 774 |
| Example 29 | 797 | 821 |
| Example 30 | 815 | 848 |
| Example 31 | 816 | 849 |
| Example 32 | 818 | 847 |
| Comparative | 502 | 577 |
| example 1 | | |
| Comparative | 511 | 527 |
| Example 2 | | |
| Comparative | 420 | 433 |
| Example 3 | | |
| Comparative | 603 | 672 |
| Example 4 | | |

As can be seen from the data in the above table, in the lithium-ion secondary battery provided in the examples of the present application, by limiting the content of a chromium element in the copper foil for a negative electrode current collector, the Cr introduced in the copper foil can improve the mechanical properties of the copper foil, such that the copper foil can well accommodate the expansion and contraction of the silicon-based negative electrode, thereby maintaining the interface stability between the copper foil and the negative electrode active material, suppressing the negative electrode expansion caused by the silicon-based material, effectively preventing the detachment of the negative electrode active material from the copper foil, and suppressing the capacity decay. By the specific regulation of the content of a fluorinated solvent and the content of a Cr element in the copper foil, it is possible to avoid reduced conductivity of the copper foil, increased internal resistance, deteriorated battery kinetics, etc., caused by the presence of the Cr element, which ensures that the lithium-ion secondary battery achieves an improved energy density while effectively preventing the electrode structure damage and the detachment of the negative electrode material, which results in an improved cycling performance.

Obviously, the above examples are merely examples given for clarity of illustration and are not intended to limit the embodiments. For those of ordinary skill in the art, other different forms of changes or variations could have also been made on the basis of the above-mentioned illustrations. There is no need to exhaustively list all embodiments herein, although it cannot be achieved. The obvious changes or variations thus derived are still within the scope of protection of the invention.

1. A lithium-ion secondary battery, comprising a positive electrode plate, a negative electrode plate, and an electrolyte,
wherein the negative electrode plate comprises a copper foil and a negative electrode active layer provided on a surface on at least one side of the copper foil, the negative electrode active layer comprising a negative electrode active material which comprises a silicon-based material and a carbon-based material, with the silicon-based material having a mass content percentage of A % based on the total mass of the negative electrode active material, where 2≤A≤50;
the copper foil comprising a Cr element, in a content of B ppm based on the total mass of the copper foil, where 5≤B≤300;
and wherein the electrolyte comprises a fluorinated solvent in a mass content percentage of C % based on the total mass of the electrolyte, where 7≤C≤70 and B/C≤50.

2. The lithium-ion secondary battery according to claim 1, wherein 1≤B/C≤50;
and the fluorinated solvent is selected from at least one of fluoro carbonates, fluoro carboxylates, fluorobenzene compounds, and fluoroethers.

3. The lithium-ion secondary battery according to claim 2, wherein the fluorinated solvent is selected from at least one of ethyl acetate with two fluorine substitutions, fluoroethylene carbonate, methyl trifluoroethyl carbonate, ethyl 2,2,2-trifluoroacetate, 1,1,2,2-tetrafluoroethyl-2,2,3,3-tetrafluoropropyl ether, 1,1,2,2-tetrafluoroethyl-2,2,2-trifluoroethyl ether, p-difluorobenzene compounds, and monofluorobenzene.

4. The lithium-ion secondary battery according to claim 2, wherein the fluorobenzene compounds have a mass content percentage of 2%-50%, based on the total mass of the electrolyte.

5. The lithium-ion secondary battery according to claim 3, wherein the p-difluorobenzene compounds comprise p-difluorobenzene.

6. The lithium-ion secondary battery according to claim 1, wherein the copper foil comprises S element, wherein the content of the S element in the copper foil is less than 20 ppm based on the total mass of the copper foil.

7. The lithium-ion secondary battery according to claim 1, wherein the copper foil has a thickness of 3 μm-10 μm;
and the copper foil has a tensile strength greater than or equal to 300 MPa.

8. The lithium-ion secondary battery according to claim 7, wherein the copper foil has a tensile strength of 300 MPa-800 MPa.

9. The lithium-ion secondary battery according to claim 1, wherein the silicon-based material comprises at least one of a silicon-carbon material and a silicon-oxygen material.

10. The lithium-ion secondary battery according to claim 9, wherein the silicon-carbon material comprises a porous carbon skeleton and silicon particles located within the pores thereof.

11. The lithium-ion secondary battery according to claim 10, wherein at least a portion of the surface of the porous carbon skeleton further comprises a carbon coating layer;
and a silicon element has a mass content percentage of 10%-80% based on the total mass of the silicon-carbon material.

12. The lithium-ion secondary battery according to claim 9, wherein the silicon-carbon material has a Dv50 of 4 μm-18 μm;
and the silicon-carbon material has an average sphericity of greater than or equal to 0.5.

13. The lithium-ion secondary battery according to claim 12, wherein the electrolyte comprises an unsubstituted carboxylate compound in a mass content percentage of 10%-70%, based on the total mass of the electrolyte.

14. The lithium-ion secondary battery according to claim 13, wherein the unsubstituted carboxylate compound comprises at least one of propyl propionate and ethyl propionate.

15. The lithium-ion secondary battery according to claim 1, wherein the lithium-ion secondary battery has a capacity of D Ah, where 2≤D≤20.

16. The lithium-ion secondary battery according to claim 1, wherein the electrolyte further comprises a lithium salt and an additive.

17. The lithium-ion secondary battery according to claim 16, wherein the additive comprises at least one of a sulfur-containing additive, a boron-containing additive or a nitrile compound.

18. A power consuming device, comprising a lithium-ion secondary battery wherein the lithium-ion secondary battery comprises a positive electrode plate, a negative electrode plate, and an electrolyte,
wherein the negative electrode plate comprises a copper foil and a negative electrode active layer provided on a surface on at least one side of the copper foil, the negative electrode active layer comprising a negative electrode active material which comprises a silicon-based material and a carbon-based material, with the silicon-based material having a mass content percentage of A % based on the total mass of the negative electrode active material, where 2≤A≤50;
the copper foil comprising a Cr element, in a content of B ppm based on the total mass of the copper foil, where 5≤B≤300;
and wherein the electrolyte comprises a fluorinated solvent in a mass content percentage of C % based on the total mass of the electrolyte, where 2≤C≤70 and B/C≤50.
